(19) United States
(12) Patent Application Publication
(10) Pub. No.: US 2016/0206500 A1
(43) Pub. Date: Jul. 21, 2016

(54) COMPRESSION DEVICE, SYSTEM, AND METHOD FOR PROMOTING CIRCULATION

(71) Applicant: SC MED INNOVATIONS, LLC, Weston, FL (US)

(72) Inventors: Steven David Steinlauf, Weston, FL (US); Wayne R. Rosen, Davie, FL (US); Pedro Joauqin Carvajal, Miami, FL (US)

(21) Appl. No.: 14/997,086

(22) Filed: Jan. 15, 2016

Related U.S. Application Data
(60) Provisional application No. 62/103,756, filed on Jan. 15, 2015.

(51) Int. Cl. A61H 9/00

(52) U.S. Cl. CPC A61H 9/0078; A61H 2205/106; A61H 2205/12; A61H 2209/00

(57) ABSTRACT

A compression system for promoting circulation including a wearable compression device having an outer shell sized and shaped to receive a user's limb. The outer shell includes an exterior surface, an opposing interior surface, a first inflation zone disposed on the interior surface, and a second inflation zone disposed on the interior surface and fluidly coupled to the first inflation zone. The compression system also includes an air tube configured to fluidly couple the first inflation zone to the second inflation zone and a compressor coupled to the compression device and the air tube. The compressor is operable to selectively inflate and deflate the first and second inflation zones in a non-sequential manner to apply pressure to at least a portion of a user's limb.

### CROSS-REFERENCE TO RELATED APPLICATION

This application claims priority to U.S. Provisional Patent Application No. 62/103,756 filed Jan. 15, 2015, the entirety of which is incorporated by reference.

### FIELD OF THE INVENTION

The present invention relates generally to a compression device, and, more particularly, relates to a compression device, system, and method for promoting circulation.

### BACKGROUND OF THE INVENTION

Deep vein thrombosis (DVT) refers to the formation of a thrombus (blood clot) within a deep vein, usually in the lower extremities. DVT may develop as a result of a medical condition effecting how the blood clots or as a result of a prolonged period of inactivity, such as that which occurs after surgery, a traumatic event, or confinement to a hospital bed. When the thrombus partially or completely blocks the flow of blood through the vein, blood begins to pool and build-up below the site, causing symptoms such as chronic swelling and pain. Moreover, the valves in the blood vessels may be damaged, leading to venous hypertension. DVT is a serious condition because if the thrombus breaks free and travels through the veins, it can reach the lungs, causing a pulmonary embolism (PE), i.e., the blocking of blood flow. A pulmonary embolism is a potentially fatal condition that can result in death within only a few hours.

Devices for treating DVT are well known. At least one known devices utilizes an external compressor, which is expensive and limits user mobility, often leading to user non-compliance. Other known devices which provide a user with a portable, self-contained apparatus for treating DVT, among other conditions, include mechanical prophylaxis, such compression sleeves, braces, and the like, that are fitted over a user's limb and connected to a pump system. The pump system may include a number of bladders designed to inflate and deflate in a sequential manner to reduce edema or provide massaging of lymph fluid in a direction toward the heart and away from the user's injured limb. Unfortunately, inflating one or more of the bladders within the sequence when the bladders are in direct contact with a user's injured limb, often subjects the user to increased pain at the site of the injured limb. As an added disadvantage, the sequential operation is not conducive for providing optimum therapy to users requiring different compression techniques in a non-sequential manner to increase circulation with the body.

Therefore, a need exists to overcome the problems with the prior art as discussed above.

### SUMMARY OF THE INVENTION

The invention provides a compression device, system, and method for promoting circulation that overcomes the hereinafore-mentioned disadvantages of the heretofore-known devices and methods of this general type and that is configured to inflate and deflate a plurality of inflation zones to apply pressure to at least a portion of a user's limb in a non-sequential manner.

With the foregoing and other objects in view, there is provided, in accordance with the invention, a compression system for promoting circulation including a wearable compression device having an outer shell sized and shaped to receive a user's limb. The outer shell includes an exterior surface and an opposing interior surface. The wearable compression device also includes a first inflation zone disposed on the interior surface and a second inflation zone disposed on the interior surface and fluidly coupled to the second inflation zone. The compression system also includes an air tube configured to fluidly couple the first inflation zone to the second inflation zone and a compressor coupled to the compression device and the air tube. The compressor is operable to selectively inflate and deflate the first and second inflation zones in a non-sequential manner to apply pressure to at least a portion of a user's limb.

In accordance with another feature, an embodiment of the present invention includes the outer shell forming a rigid housing sized and shaped to substantially surround a user's limb and having a front portion and a rear portion removably couplable to the front portion.

In accordance with a further feature of the present invention, the exterior surface defines at least one aperture and the air tube is coupled to at least one of the first inflation zone and the first inflation zone through the at least one aperture.

In accordance with another feature of the present invention, the first inflation zone includes at least a first flexible bladder configured to be disposed along a user's calf and the second inflation zone includes at least a second flexible bladder configured to be disposed beneath a user's foot.

In accordance with another feature of the present invention, the compression system includes an interior padding defining a gap sized and shaped to receive the first flexible bladder within the gap.

In accordance with a further feature of the present invention, the compression system includes at least one pressure sensor coupled to the compressor and configured to sense a pressure level associated with at least one of the first inflation zone and the second inflation zone.

In accordance with yet another feature of the present invention, the compression system includes a metallic marker coupled to at least one of the outer shell and a user's limb and a metallic marker sensor communicatively coupled to the metallic marker and the compressor, the metallic marker sensor operably configured to prevent activation of inflation of at least one of the first inflation zone and the second inflation zone as a result of the metallic marker sensor being within a distance of the metallic marker.

In accordance with another feature of the present invention, the compression system includes a third inflation zone fluidly coupled to the compressor. The compressor is operably configured to selectively inflate and deflate the first inflation zone and at least one of the second inflation zone and the third inflation zone in a non-sequential manner to apply pressure to at least a portion of a user's limb.

In accordance with yet another feature of the present invention, the first inflation zone is disposed above the second inflation zone and the compressor is operably configured to inflate the first inflation zone at a point in time prior to inflation of the second inflation zone.

In accordance with another feature, an embodiment of the present invention also includes a compression system for promoting circulation in a non-sequential manner including an outer shell sized and shaped to substantially surround a user's limb. The outer shell defines an interior housing sized to receive a user's limb within the interior housing. The compression system also includes a first inflation zone disposed within the interior housing, a second inflation zone disposed within the interior housing below the first inflation zone, an air tube configured to fluidly couple the first inflation zone to the second inflation zone, and a compressor coupled to the air tube. The compressor is operable to selectively inflate and deflate the first and second inflation zones in a non-sequential manner to apply pressure to at least a portion of a user's limb. The compression system may also include at least one pressure sensor coupled to the compressor. The at least one pressure sensor is operably configured to sense a pressure level provided by the compressor to at least one of the first and second inflation zones.

In accordance with another feature of the present invention, the compression system includes a third inflation zone fluidly coupled to the compressor and the compressor is operably configured to selectively inflate and deflate at least two of the first inflation zone, the second inflation zone, and the third inflation zone in a non-sequential manner to apply pressure to at least a portion of user's limb.

In accordance with yet another feature of the present invention, the compression system includes a controller operably configured to inflate and deflate the first and second inflation zones according to a predetermined user treatment regimen stored in memory communicatively coupled to the controller.

In accordance with a further feature of the present invention, the compression system includes a metallic marker coupled to at least one of the outer shell and a user's limb and a metallic marker sensor communicatively coupled to the metallic marker and the compressor, the metallic marker sensor operably configured to prevent inflation of at least one of the first inflation zone and the second inflation zone as a result of the metallic marker sensor being within a distance of the metallic marker.

In accordance with a further feature of the present invention, the first inflation zone includes at least one flexible bladder configured to be disposed along a user calf and the second inflation zone includes at least one flexible bladder configured to be disposed beneath a user foot.

In accordance with another feature of the present invention, the compression system includes an air flow control unit and a device storage unit coupled to the outer shell for storing the air flow control unit and the compressor.

In accordance with another feature of the present invention, the compression system includes a transmitter coupled to the at least one pressure sensor and a processor communicatively coupled to the transmitter. The process is configured to receive data associated with the at least one pressure sensor from the transmitter.

In accordance with the present invention, a method for promoting circulation is disclosed that includes providing a compression system for promoting circulation including a wearable compression device having an outer shell sized and shaped to substantially surround a user's limb. The outer shell includes an exterior surface and an opposing interior surface. The compression device also includes a first inflation zone disposed on the interior surface and a second inflation zone disposed on the interior surface and fluidly coupled to the first inflation zone. The compression system includes at least one pressure sensor communicatively coupled to at least one of the first inflation zone and the second inflation zone, an air tube configured to fluidly couple the first inflation zone to the second inflation zone, and a compressor coupled to the compression device and the air tube, the compressor operable to selectively inflate and deflate the first and second inflation zones in a non-sequential manner to apply pressure to at least a portion of a user's limb. The method includes coupling the at least one pressure sensor to at least one of the first inflation zone and the second inflation zone and selectively inflating at least one of the first inflation zone and the second inflation zone in a non-sequential manner.

In accordance with another feature of the present invention, the method includes providing the compression device having a third inflation zone disposed on the interior surface and selectively inflating at least two of the first inflation zone, the second inflation zone, and the third inflation zone in a non-sequential manner.

In accordance with a further feature of the present invention, the method includes providing a metallic marker and a metallic marker sensor communicatively coupled to the metallic marker and the compressor, the metallic marker sensor operably configured to prevent inflation of at least one of the first inflation zone and the second inflation zone as a result of the metallic marker sensor being within a distance of the metallic marker and placing the metallic marker adjacent to an injured user's limb.

In accordance with another feature of the present invention, the method includes providing a user compliance monitoring system including a transmitter coupled to the at least one pressure sensor and configured to transmit data generated by the at least one pressure sensor to a processor communicatively coupled to the transmitter, coupling the at least one pressure sensor to the at least one of the first inflation zone and the second inflation zone, reviewing the data generated by the at least one pressure sensor and comparing the data to a predetermined treatment regimen.

Although the invention is illustrated and described herein as embodied in a compression device, system, and method for promoting circulation, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. In this document, the term “longitudinal” should be understood to mean in a direction corresponding to an elongated direction of the wearable compression device from an end that makes contact with a ground surface to an ascending direction. The terms “program,” “software application,” and the like as used herein, are defined as a sequence of instructions designed for execution on a computer system. A “program,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is a right front perspective view of a compression system including a compression device in accordance with the present invention;

FIG. 2 is a right rear perspective view of the compression device of FIG. 1 depicting the compression device having a front portion and a rear portion in accordance with the present invention;

FIG. 3 is a cross-sectional view of the compression device of FIG. 1 at section A3-A3 depicting an interior housing, as well as a first inflation zone and a second inflation zone each having at least one flexible bladder in a deflated configuration;

FIG. 4 is a cross-sectional view of the compression device of FIG. 1 at section A3-A3 depicting the first inflation zone, the second inflation zone, and a third inflation zone coupled to an air tube;

FIG. 5 is a cross-sectional view of the compression device of FIG. 1 at section A3-A3 depicting first inflation zone and the second inflation zone each having the flexible bladder of FIG. 3 in an inflated configuration and coupled to the air tube and a compressor stored within a device storage unit in accordance with the present invention;

FIG. 6 is a cross-sectional view of the compression device of FIG. 1 at section A3-A3 depicting a pressure sensor coupled to the compression device in accordance with an exemplary embodiment of the present invention;

FIG. 7 is an elevational side view of the compression device of FIG. 1 depicting the air tube contouring an exterior surface of the compression device in accordance with the present invention; and

FIG. 8 is a process-flow diagram depicting a method of promoting circulation in accordance with one embodiment of the present invention.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

The present invention provides a novel and efficient compression system including a wearable compression device having one or more inflation zones in contact with a user's limbs. The compression system provides the user with the ability to inflate and deflate the inflation zones in a non-sequential manner to promote blood circulation. The term “non-sequential” is defined herein as not in sequence or in a particular order or pattern. Said another way, the term “non-sequential” includes the ability to selectively inflate one or more inflation zones in any particular order, regardless of whether the inflation zones are adjacent to each other. As such, the user can apply pressure to select areas of the body to stimulate blood flow and reduce the chances of the user developing DVT, i.e., the blood pooling and clotting, while simultaneously bypassing an injured limb so as not to expose the injured limb to unnecessary pain that would otherwise be incurred through the application of pressure directly to the injured limb.

The compression system, however, is not limited to operating in the non-sequential manner, but may also operate in a sequential manner. In contrast to the term “non-sequential,” the term “sequential” is defined herein as activating adjacent inflation zones in a particular order or sequence. For example, the term “sequential” may include inflating a distal inflation zone, then one or more inflation zones in a proximal direction away from the distal inflation zone, with the distal inflation zone always being inflated prior to the proximal inflation zone. Embodiments of the invention provide the compression device configured as a controlled ankle movement walker (“CAM walker”) coupled to an air tube and a compressor that may be neatly housed within a device storage unit on a front portion of the compression device so as to effectuate proper weight distribution. In addition, embodiments of the invention provide at least one pressure sensor coupled to the compressor that is operably configured to sense a pressure level provided by the compressor to the inflation zones to elicit feedback that may be effectively used to develop appropriate treatment regimens for the user, especially for those users suffering from conditions such as DVT.

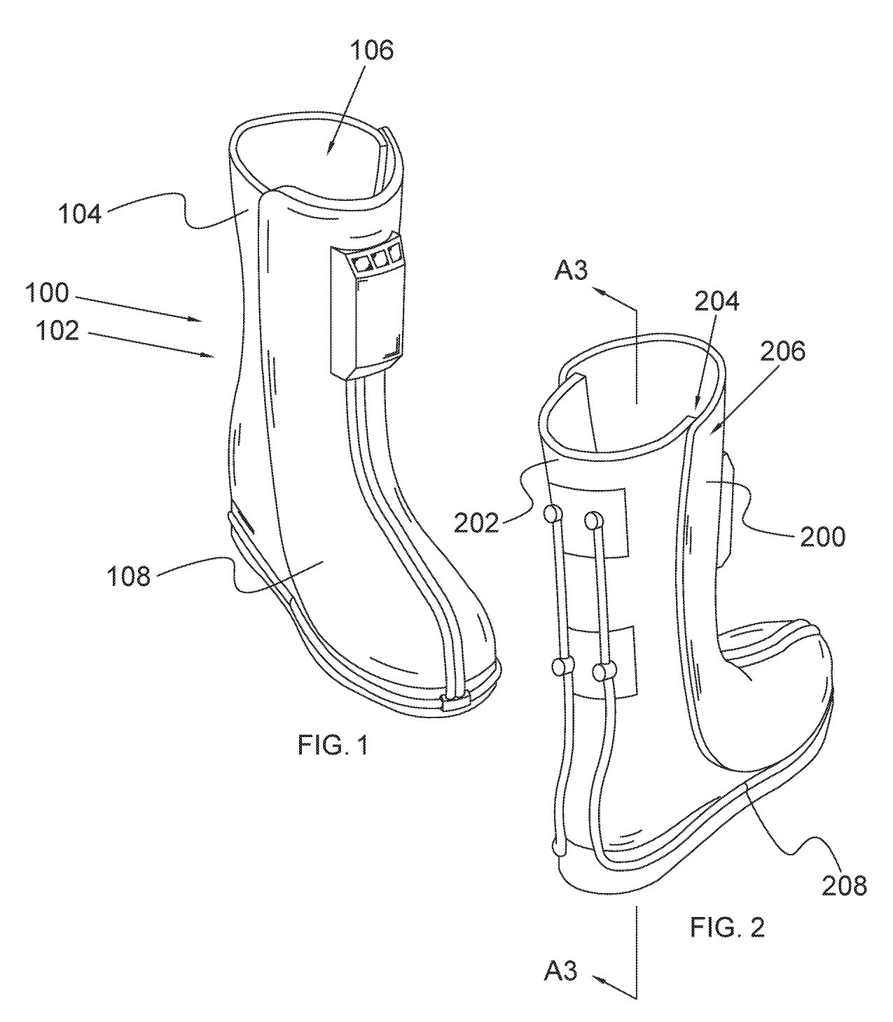

Referring now to FIG. 1, one embodiment of the present invention is shown in a front perspective view. FIG. 1 shows several advantageous features of the present invention, but, as will be described below, the invention can be provided in several shapes, sizes, combinations of features and components, and varying numbers and functions of the components. The first example of a compression system 100, as shown in FIG. 1, includes a wearable compression device 102 having an outer shell 104 defining an interior housing 106 sized and shaped to substantially surround one or more user's limbs, e.g., a foot, calf, leg, arm, etc. The term “substantially surround” is defined herein as to surround at least 75% of a user's limb on all sides and may include a nominal opening on one or more sides.

In one embodiment, the compression device 102 is a CAM walker. In other embodiments, the compression device 102 may be another type of brace. In one embodiment, the outer shell 104 may be rigid. The term “rigid” is defined herein as difficult to bend or flex. In preferred embodiments, in order to prevent or limit the movement of a particular limb, the compression device 102 may be made from, without limitation, a durable pre-molded synthetic material, such polyethylene, polyvinyl chloride (PVC), nylon, etc. As an added advantage, the durable material is suitable for supporting the mechanical and electrical components utilized to operate the compression system 100, as described in further detail below. In other embodiments, the compression device 102 may be made of a flexible material, e.g., a breathable cotton material, heavy duty jersey, and the like. In embodiments in which the outer shell 104 is configured to be fitted to a user's lower limb, the outer shell 104 may transition from an approximate 4.0-5.0 centimeter thickness in the calf area to an approximate 0.5 to 1.0 centimeter thickness in the forefoot and toe area of the outer shell.

FIG. 1 depicts the outer shell 104 having an outer sole 108 which may also be made from a durable material to provide further support to the user's limb while simultaneously reducing resistance to water and other fluids, as well as outside elements. In one embodiment, the outer sole 108 is made of a natural rubber, polyurethane, PVC, or another durable material. In other embodiments, the outer sole 108 may be made of another durable material.

With reference now to FIGS. 1 and 2, in one embodiment, the outer shell 104 includes a front portion 200 removably couplable to a rear portion 202. In one embodiment, the front and rear portions 200, 202 may be coupled to each other using one or more interior fasteners, as discussed in further detail below. As best shown in FIG. 2, the front portion 200 may overlap the rear portion 202 at an overlapping juncture 204 to provide a user, especially those having a foot or other lower extremity injury, with the ability to easily decouple the front portion 200 from the rear portion 202. In other embodiments, an exterior fastener (not shown) may be disposed on an exterior surface 206 of the outer shell 104. The exterior fastener may be a side release buckle, snap fastener, or the like, allowing a speedy release of the front portion 200 from the rear portion 202. The overlapping juncture 204 permits the user to conveniently adjust the compression device 102 to suit the user's individual size and shape. In other embodiments the front portion 200 and the rear portion 202 may form an integral unit.

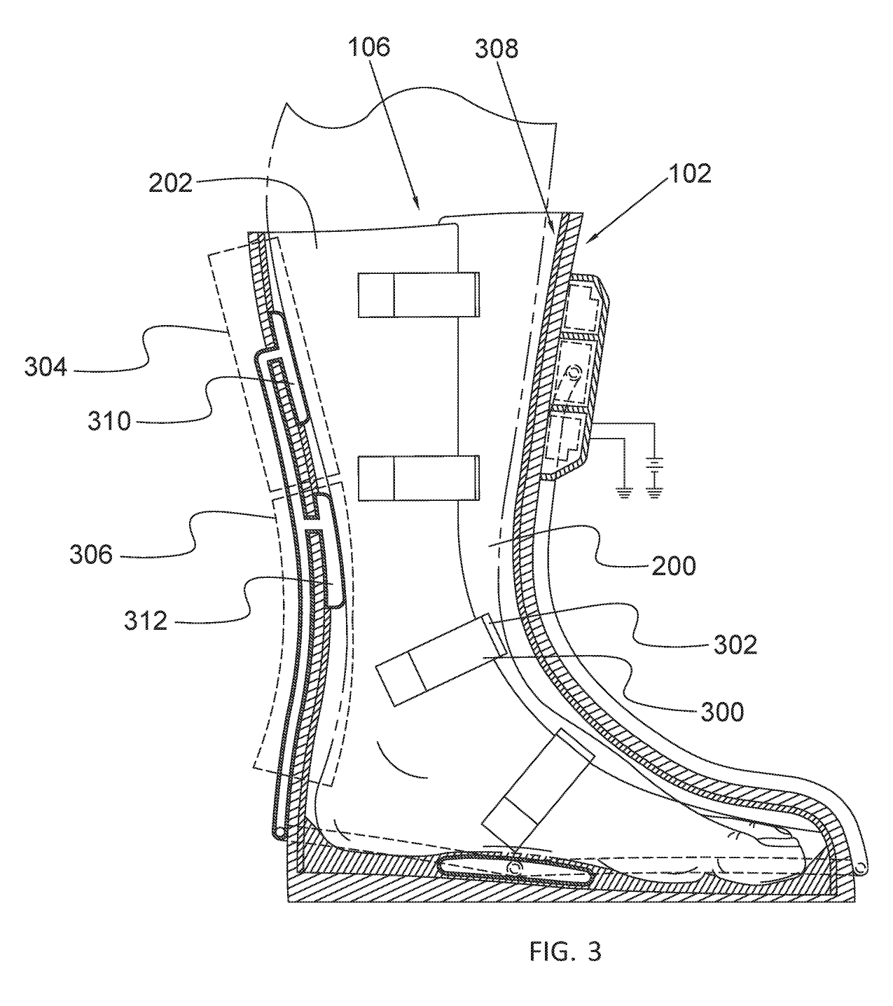

With reference now to FIG. 3, a cross-sectional view of the interior housing 106 is depicted along section A3-A3 of FIG. 2. Generally speaking, the front portion 200 may be coupled to the rear portion 202 in an overlapping relationship using one or more interior fasteners, e.g., a male fastener 300 coupled to a female fastener 302. For example, a translatable strap (e.g., male fastener 300) may be inserted into an opening of a loop (e.g., female fastener 302) and thereafter pulled, preferably in a direction away from the opening to adjust the fit of the compression device 102 to the user's comfort level. Although FIG. 3 depicts four male fasteners 300 coupled to four female fasteners 302, more or less fasteners may be utilized. In other embodiments one or more buckles, clasps, hook and loop attachments, and the like may be used to couple the front portion 200 to the rear portion 202.

With reference still to FIG. 3, the compression device 102 can be seen having a first inflation zone 304 disposed above a second inflation zone 306 on an interior surface 308 of the compression device 102. In one illustrative embodiment, the first inflation zone 304 includes at least a first flexible bladder 310 and the second inflation zone 306 includes at least a second flexible bladder 312 respectively, disposed along a user's calf. The first and second inflation zones 304, 306 and flexible bladders 310, 312, however, may be disposed along other portions of the user's body, such as along the user's foot, leg and/or arm. The first and second inflation zones 304, 306 may also each include two or more flexible bladders 310, 312. FIG. 3 depicts the flexible bladders 310, 312 in a deflated configuration.

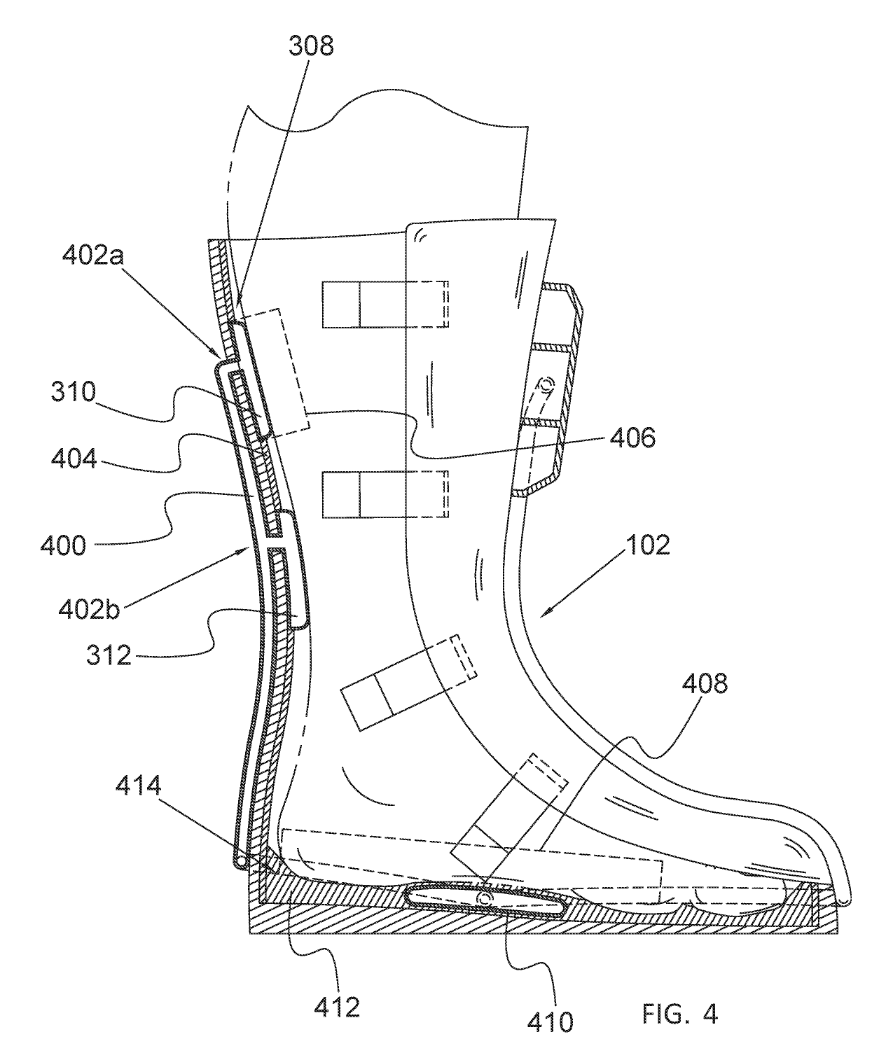

With reference now to FIG. 4, the flexible bladders 310, 312 are again depicted in the deflated configuration. In order to provide the transition between an inflated and the deflated configurations, the flexible bladders 310, 312 operate in conjunction with an air tube 400 fluidly coupled thereto which allows air to selectively travel to and from the flexible bladders 310, 312, as will be explained in further detail below. In other embodiments, fluid, e.g., water, may be utilized instead of air. As such, the flexible bladders 310, 312 may be inflated with air to supply pressure to a portion of select limbs, thereby increasing blood circulation and decreasing or preventing swelling and the chances of the user developing harmful conditions, such as DVT. The “portion” of the user's limb is defined herein in its broadest possible sense and may include a section of the user's leg, calf, foot, etc.

With reference to FIGS. 2 and 4, in one embodiment, the exterior surface 206 defines a plurality of channels (not shown) along the exterior surface 206 which each define an indentation for securing the air tube 400 within the indentation along the exterior surface 206 with little concern of outside obstructions. In one embodiment, the exterior surface 206 defines one or more apertures 402a-b (FIG. 4), which may be formed through a drill hole for example, for receiving the air tube 400 through the apertures 402a-b to couple the air tube 400 to the flexible bladders 310, 312 within the first and second inflation zones 304, 306 (FIG. 3). In other embodiments, the air tube 400 may be coupled to the compression device 102 through another configuration.

Unlike those known devices having air tubes which span continuously from a first end to a second end of the air tube, the air tube 400 enables a user to quickly disconnect at least a portion of the air tube 400 using an air tube fastener 208 (FIG. 2), which users find extremely beneficial because such configuration allows the user to release the pressure within the air tube 400 in emergency situations. The air tube fastener 208 may be a quick disconnect coupling, a general purpose tube fitting, or the like.

With reference specifically to FIG. 4, the interior surface 308 can be seen having an interior padding 404 defining a gap 406 sized and shaped to receive the inflatable bladder 310 within the gap 406 to secure the inflatable bladder 310 in a stationary position. The size and shape of the gap 406 may vary in accordance with the size of the inflatable bladder 310. In one embodiment, the interior padding 404 is a resilient padding capable of regaining its original shape after being compressed to provide cushioned support to the user's limb. More specifically, the interior padding 404 may be, without limitation, cotton or an elastic material, e.g., silicone rubber, neoprene, etc.

FIG. 4 further depicts the compression device 102 having a third inflation zone 408 including a third flexible bladder 410 disposed beneath a user's foot. Similar to the first and second inflation zones 304, 306 (FIG. 3) and flexible bladders 310, 312, the third flexible bladder 410 may be disposed along other portions of the user's body in lieu of the user's foot, such as along the user's leg and/or arm, and may also include two or more flexible bladders.

In one embodiment, a foot support padding 412 is disposed along a bottom portion 414 of the interior surface 308. More specifically, the foot support padding 412 is disposed along an area where the generally plantar surface of a user's foot may rest within the compression device 102. The foot support padding 412 may include a heating element, e.g., a heated gel pad, which supplies heat to the foot to decrease potential muscle spasms and open up the blood vessels, thereby increasing blood flow and the supply of oxygen and nutrients in an effort to reduce foot pain.

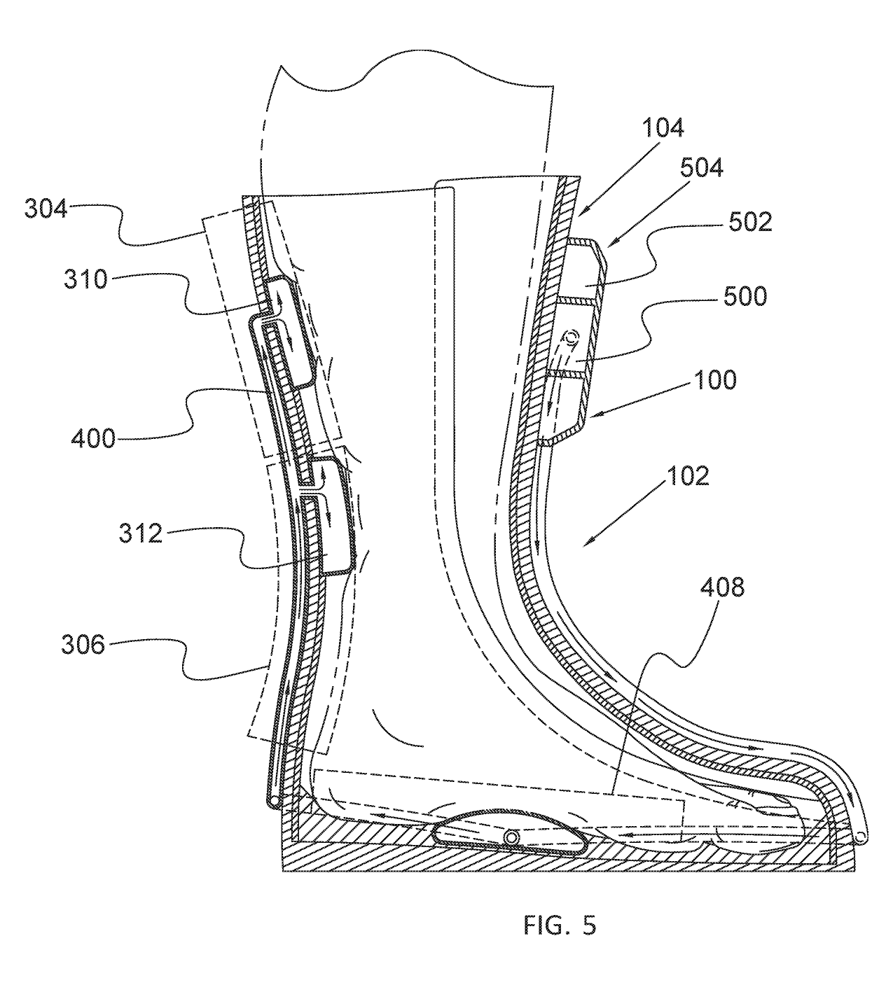

With reference now to FIG. 5, the compression device 102 can be seen with the air tube 400 fluidly coupled to a compressor 500 for providing the flexible bladders 310, 312 in the inflated configuration, as shown. In one embodiment, the compressor 500 is an aerosol compressor. In another embodiment, the compressor 500 may be a pneumatic compressor or an alternative lightweight compressor.

In one embodiment, the compression system 100 presents a significant advantage over other devices used to treat DVT, as the compressor 500 may be configured to selectively inflate and deflate the first inflation zone 304 alone or in conjunction with at least one of the second inflation zone 306 and the third inflation zone 408 in a non-sequential manner to apply pressure to at least a portion of user's limb. Said another way, in one illustrative embodiment, the non-sequential manner may include inflating the first inflation zone 304, the third inflation zone 408, and subsequently the second inflation zone 306. In another embodiment, the non-sequential manner may include inflating the first inflation zone 304 and the third inflation zone 408, but not inflating the second inflation zone 306. It is to be understood that such examples are provided for illustrative purposes only and the non-sequential manner may include other inflation commands. In contrast to the non-sequential manner, in other embodiments, the compressor 500 may be configured to inflate the inflation zones 304, 306, 408 in the sequential manner. In one embodiment, the sequential manner includes selectively inflating the third inflation zone 408, then the second inflation zone 306, and subsequently the first inflation zone 304 so as to move fluid from a distal to proximal direction, i.e., towards the user's chest. It is to be understood that such examples are provided for illustrative purposes only and the sequential manner may include other inflation commands.

Advantageously, the compression system 100 provides the user with the ability to selectively place the inflation zones 304, 306, 408 to select areas of the user's body to apply pressure to the select areas of the body, while effectively bypassing an injured limb, so as not to expose the injured limb to unnecessary pain that would otherwise be incurred through the application of pressure directly to the injured limb. For example, a user with an injured lower calf muscle may benefit from the application of pressure applied through an inflation zone directly to an upper calf muscle and the foot, yet may wish to avoid the application of pressure directly to the injured lower calf muscle. In the same vein, in another example, a user with an injured ankle may desire to avoid pressure being applied directly to the ankle, yet may benefit from pressure being applied to the calf and/or foot through one or more inflation zones.

The compressor 500 may be provided with a battery (not shown) and an air flow control unit 502. Advantageously, in one embodiment, the battery and air flow control unit 502 may be conveniently stored within a device storage unit 504 coupled to the outer shell 104. In a preferred embodiment, the device storage unit 504 is disposed on an anterior portion of the outer shell 104 proximal to the location of the user's shin to effectuate proper weight distribution. In other embodiments, the device storage unit 504 may disposed above the user's toe area or at another location on the compression device 102. The device storage unit 504 is defined herein in its broadest possible sense and may be any lightweight storage container, e.g., a lightweight plastic container.

The air flow control unit 502 may be a mechanical system, an electronic system, and/or a software based system. In one exemplary embodiment, the air flow control unit 502 is formed as a hand-held control with the controls being operable by way of user input via a touchscreen. In other embodiments, the air flow control unit 502 may be another controller that is lightweight for easy portability.

The air flow control unit 502 may include one or more actuators that allow the user to control one or more of the following functions of the compression system 100: turning the compression system on and off, dispensing air to one or more of the flexible bladders 310, 312, 410 within one or more of the inflation zones 304, 306, 408, deflating one or more of the flexible bladders 310, 312, 410 within one or more of the inflation zones 304, 306, 408, etc. For example, the air flow control unit 502 may operably configured to inflate and deflate the first, second, and/or third inflation zones 304, 306, 408 according to a predetermined patient regimen, e.g., a series of intervals wherein each interval includes 45 seconds of inflation and 15 seconds of deflation. In further embodiments, the air flow control unit 502 may be communicatively coupled to other types of actuators that control further functions of the compression system 100.

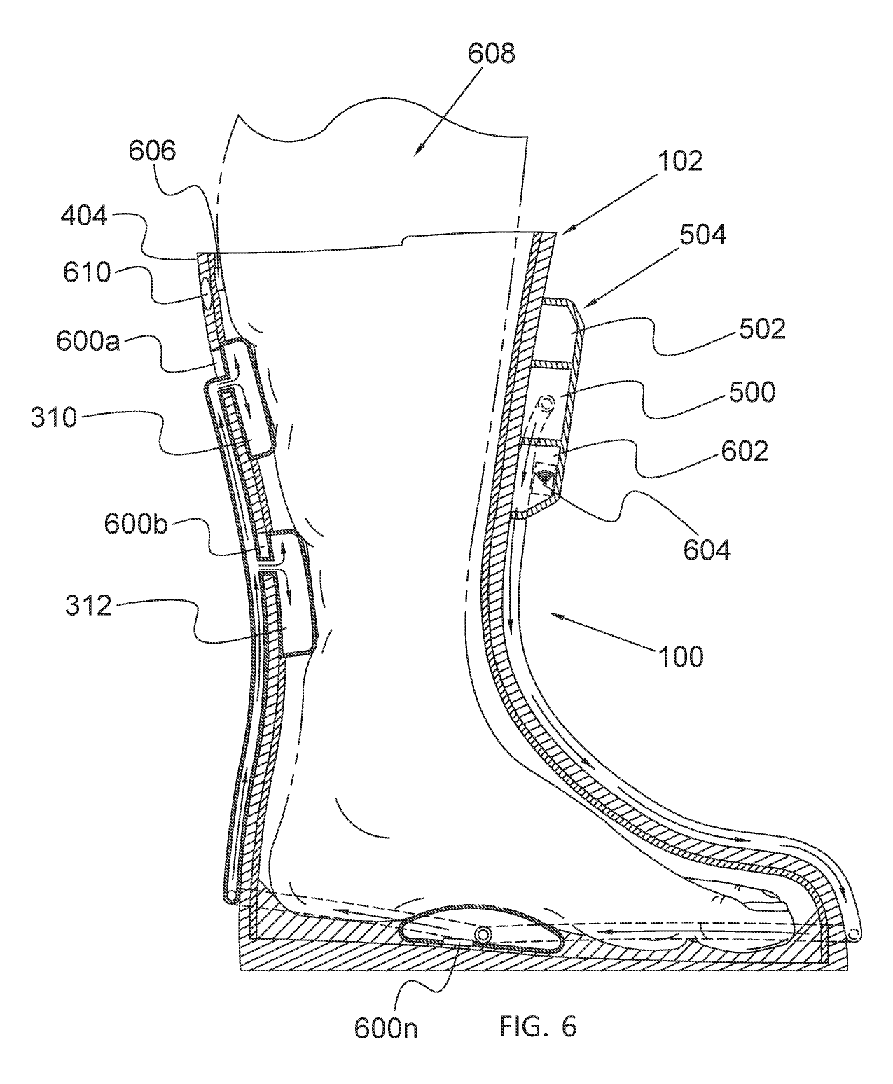

With reference now to FIG. 6, in one advantageous embodiment, the compression system 100 includes the air flow control unit 502 communicatively coupled to at least one pressure sensor 600a. In one embodiment, the pressure sensor 600a is configured to sense a pressure level within at least one of the first and second flexible bladders 310, 312. Said another way, the pressure sensor 600a may be communicatively coupled to either of both of the flexible bladders 310, 312. In other embodiments, the compression system 100 may include a plurality of pressure sensors 600a-n, wherein the indicator “a-n” is intended to represent any number of items, with “a” indicating 1 and “n” indicating any number greater than 1. In this embodiment, the number of pressure sensors may correspond to the number of flexible bladders 310, 312.

In one embodiment, the pressure sensor 600 may be removably coupled within the interior padding 404 such that the user and/or the healthcare provider may remove the pressure sensor 600 to obtain a pressure reading of the flexible bladder 310. For example, it may be desirable for the healthcare provider to review the pressure reading when the pressure level becomes intolerant for the user. In the same vein, the pressure sensor 600 may include a speaker, vibrator, display, etc. to effectively provide audio, vibratory, or visual feedback to signal the user or healthcare provider that the pressure has reached a maximum predetermined threshold.

In one embodiment, the compression system 100 may also include a processor 602 communicatively coupled (wired or wirelessly) to the pressure sensors 600a-n. In one embodiment, the processor 602 is coupled to the device storage unit 504. In another embodiment, the processor 602 may be separated from the compression device 102 and may be in the form of a computer, tablet, smartphone, laptop, or the like. The processor 602 may be operably configured to receive data produced by the pressure sensors 600a-n through a transmitter 604. The transmitter 604 may be a wireless transmitter/receiver that operates using a radio transmitter, Bluetooth transceiver, Wi-Fi, etc. In addition to providing the pressure level, the data provided by the pressure sensors 600a-n may include information associated with the user's blood pressure, such as data associated with the user's blood flow through the leg arteries. For example, when the pressure sensor 600a is disposed adjacent to the user's calf and the pressure sensor 600b is disposed adjacent to the user's arm, the difference in pressure between the pressure sensors 600a-b, if any, may be measured. The difference in pressure may be used to determine whether there is a buildup within the leg arteries interfering with circulation. In such configuration, the pressure sensors 600a-b may operate using Doppler ultrasound or another suitable technique. In another example, the pressure sensors 600a-b may be disposed adjacent to different areas of the user's leg such that blood pressure measurements may be obtained at different locations along the leg. Such measurements may be used to assist the healthcare provider in determining whether the user has any arterial narrowing and the location thereof, if applicable.

In one embodiment, the compression system 100 includes a memory having a database coupled to the processor 602 for storing the data from the pressure sensors 600a-n. Advantageously, the data stored within the memory may be monitored and analyzed by the user or a healthcare provider, e.g., a physician. As such, the compression system 100 provides the healthcare provider with the ability to tailor the necessary series of inflation intervals in accordance with the individual user's needs as part of a user compliance monitoring system.

In use, in one exemplary embodiment, the processor 602 may be configured to instruct the air flow control unit 502 to deactivate the compressor 500 when the pressure sensor 600a indicates that the pressure level within the first flexible bladder 310 or the second flexible bladder 312 reaches a certain maximum threshold. This not only increases the user's comfort level but also increases the safety of the compression system 100, especially for those experiencing forgetfulness, dementia, or other debilitating disorders. In another embodiment, the user may utilize the air flow control unit 502 to deactivate the compressor 500 when the pressure level within one or more of the flexible bladders becomes uncomfortable for the user. The pressure level and the duration in which the flexible bladders 310, 312 are active may be recorded such the data can be reviewed and analyzed by the healthcare provider.

In one embodiment, to further increase the user's comfort and avoid the application of pressure to an injured limb, the compression system 100 includes a metallic marker 606 coupled to the user's injured limb 608 or along the compression device 102 at a location adjacent to the injured limb 608. The metallic marker 606 radiates a small magnetic field which may be detected by a metallic marker sensor 610 used to detect the position of the metallic marker 606. The metallic marker sensor 610 may wirelessly communicate via a wireless connection the position of the metallic marker 606 to the processor 602 to instruct the air flow control unit 502 to prevent activation of the compressor 500 inflating either or both flexible bladders 310, 312 as a result of the metallic marker sensor 610 being within a distance of the metallic marker 606. In one embodiment, the distance includes the metallic marker sensor 610 being within 0-4.0 inches of the metallic marker 606. In other embodiments, the distance may be greater than 4.0 inches.

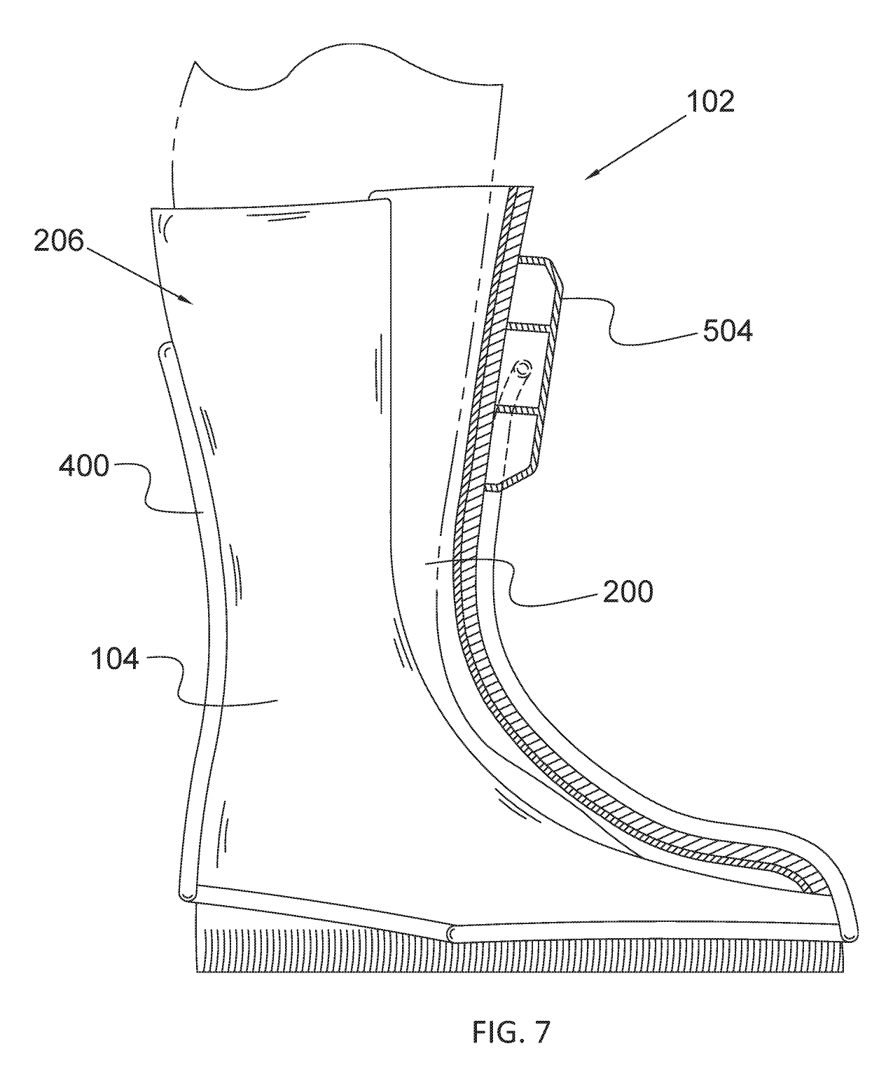

With reference now to FIG. 7, an elevational side view of the compression device 102 is depicted showing the device storage unit 504 disposed on the front portion 200 of the compression device 102. Advantageously, this configuration provides a user with a portable device storage unit 504 that does not require a connection to an external compressor, thus increasing the probability of user compliance. Moreover, coupling the device storage unit 504 adjacent to the user's shin generally provides a greater level of stability for the user than that which would occur if the device storage unit 504 were placed adjacent to the user's foot. FIG. 7 also depicts the air tube 400 neatly contouring the exterior surface 206 of the outer shell 104 so as to allow the user easy access to the air tube 400 in the event a quick disconnect is necessary, thus further increasing the safety features of the compression device 102. Although the depicted compression device 102 is for a user's calf and foot area, it is understood that the compression device 102 may be configured for use in other areas of the user's body.

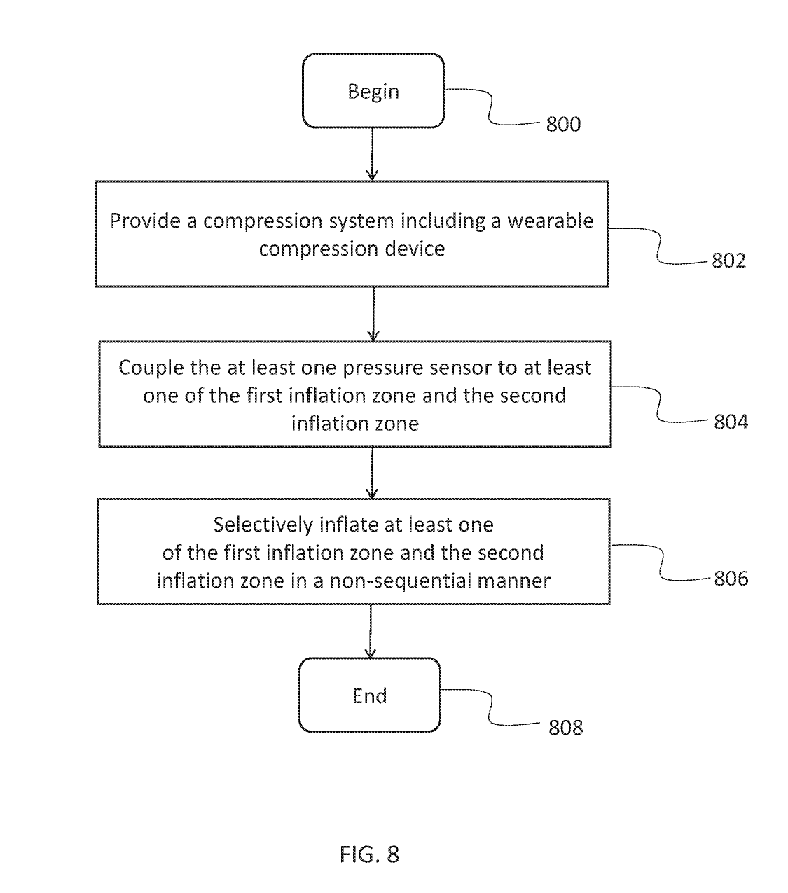

With reference now to the process flow chart of FIG. 8, in conjunction with FIGS. 1-7, an exemplary method of promoting circulation and more specifically, blood circulation within a human body, is shown. Although FIG. 8 shows a specific order of executing the process steps, the order of executing the steps may be changed relative to the order shown in certain embodiments. Also, two or more blocks shown in succession may be executed concurrently or with partial concurrence in some embodiments. Certain steps may also be omitted in FIG. 8 for the sake of brevity. In some embodiments, some or all of the process steps included in FIG. 8 can be combined into a single process.

In said process, the method begins at step 800 and immediately proceeds to step 802 of providing a compression system including a wearable compression device, such as the compression system 100 and the compression device 102 described above. In one embodiment, the compression device 102 includes an outer shell sized and shaped to substantially surround a user's limb. The user's limb may be a lower limb, e.g., a calf, foot, leg, etc., and/or an upper limb, e.g., the user's arm, or any combination thereof In one embodiment, the outer shell includes an exterior surface having a front portion removably couplable to a rear portion. In other embodiments, the front and rear portions may be fixedly coupled to each other. The outer shell also includes the exterior surface having an opposing interior surface, a first inflation zone disposed on the interior surface, and a second inflation zone disposed on the interior surface and fluidly coupled to the second inflation zone through an air tube. In other embodiments, the compression device may include a third inflation zone disposed on the interior surface. For brevity, the compression system has been described with three inflation zones, however the number of inflation zones may be greater than three, with the additional inflation zones operating in the same manner as the described with respect to the first, second, and/or third inflation zones.

The first, second, and third inflation zones may each include one or more flexible bladders in contact with the user's limbs. In one embodiment, the flexible bladders are configured to be selectively inflated and deflated in a non-sequential manner using air supplied through an air tube acting in conjunction with a compressor. In another embodiment, the flexible bladders may be configured to selectively inflate and deflate in a sequential manner.

In one embodiment, the compression system includes at least one pressure sensor. In step 804, the pressure sensor is communicatively coupled by the user, the healthcare provider, or the like, to at least one of the first inflation zone and the second inflation zone, and, more specifically, the flexible bladders. In embodiments having the third inflation zone, one or more pressure sensors may be communicatively coupled to the third inflation zone. The pressure sensor is configured to analyze data, e.g., the amount of pressure applied to the user's limbs through the flexible bladders, the user's blood pressure, and the like.

Next, the process continues to step 806 of at least one of the user, the healthcare provider, or the processor selectively inflating and deflating at least one of the first inflation zone and the second inflation zone in a non-sequential manner. In such advantageous configuration, circulation may be provided from various areas of the body at any given time. For example, pressure may be simultaneously applied to an upper limb and a lower limb for a duration to promote blood circulation throughout the body. In one embodiment, the third inflation zone may be inflated in the non-sequential manner in conjunction with either or both of the first inflation zone and the second inflation zone, as described in further detail above. In other embodiments, the first, second, and/or third inflation zones may be selectively inflated and deflated in a sequential manner.

In one embodiment, the pressure sensor may be removed by the user or a healthcare provider to analyze data provided by the pressure sensor. In another embodiment, the pressure sensor may be communicatively coupled to a transmitter configured to transmit data generated by the pressure sensor to a processor. The processor may be coupled to the compression device or may be, without limitation, a computer, laptop, smart phone, tablet or other electronic device separate from the compression device. The data provided by the pressure sensor may be used as part of a user compliance tracking system in which a healthcare provider may compare the data received to a predetermined treatment regimen.

The process may also include providing a metallic marker and a metallic marker sensor communicatively coupled to the metallic marker and the compressor, as described above. The metallic marker may be placed adjacent to an injured user's limb or on the compression device. The metallic marker sensor is operably configured to prevent inflation of one or more inflatable bladders as a result of the metallic marker sensor being within a distance, e.g., 0-4.0 inches of the metallic marker, thus increasing the safety features of the compression system. In other embodiments, the distance may be outside of this range. The process then terminates at step 808.

A compression system has been disclosed that not only provides a user with the ability to apply pressure in a non-sequential manner to select areas of the body to stimulate blood flow and reduce the chances of the user developing DVT, but also increases the probability of user compliance. Embodiments of the invention also provide a healthcare provider with user compliance data for developing appropriate treatment regimens.

What is claimed is:

1. A compression system for promoting circulation comprising:
a wearable compression device having:
an outer shell sized and shaped to receive a user's limb, the outer shell having:
an exterior surface; and
an opposing interior surface;
a first inflation zone disposed on the interior surface; and
a second inflation zone disposed on the interior surface and fluidly coupled to the second inflation zone;
an air tube configured to fluidly couple the first inflation zone to the second inflation zone; and
a compressor coupled to the compression device and the air tube, the compressor operable to selectively inflate and deflate the first and second inflation zones in a non-sequential manner to apply pressure to at least a portion of a user's limb.

2. The compression system according to claim 1, wherein:
the outer shell forms a rigid housing sized and shaped to substantially surround a user's limb and having:
a front portion; and
a rear portion removably couplable to the front portion.

3. The compression system according to claim 1, wherein:
the exterior surface defines at least one aperture; and
the air tube is coupled to at least one of the first inflation zone and the first inflation zone through the at least one aperture.

4. The compression system according to claim 1, wherein:
the first inflation zone includes at least a first flexible bladder configured to be disposed along a user's calf; and
the second inflation zone includes at least a second flexible bladder configured to be disposed beneath a user's foot.

5. The compression system according to claim 4, further comprising:
an interior padding defining a gap sized and shaped to receive the first flexible bladder within the gap.

6. The compression system according to claim 1, further comprising:
at least one pressure sensor coupled to the compressor and configured to sense a pressure level associated with at least one of the first inflation zone and the second inflation zone.

7. The compression system according to claim 1, further comprising:
a metallic marker coupled to at least one of the outer shell and a user's limb; and
a metallic marker sensor communicatively coupled to the metallic marker and the compressor, the metallic marker sensor operably configured to prevent activation of inflation of at least one of the first inflation zone and the second inflation zone as a result of the metallic marker sensor being within a distance of the metallic marker.

8. The compression system according to claim 1, further comprising:
a third inflation zone fluidly coupled to the compressor, the compressor operably configured to selectively inflate and deflate the first inflation zone and at least one of the second inflation zone and the third inflation zone in a non-sequential manner to apply pressure to at least a portion of a user's limb.

9. The compression system according to claim 1, wherein:
the first inflation zone is disposed above the second inflation zone; and
the compressor is operably configured to inflate the first inflation zone at a point in time prior to inflation of the second inflation zone.

10. A compression system for promoting circulation in a non-sequential manner comprising:
an outer shell sized and shaped to substantially surround a user's limb, the outer shell defining:
an interior housing sized to receive a user's limb within the interior housing;
a first inflation zone disposed within the interior housing;
a second inflation zone disposed within the interior housing below the first inflation zone;
an air tube configured to fluidly couple the first inflation zone to the second inflation zone;
a compressor coupled to the air tube, the compressor operable to selectively inflate and deflate the first and second inflation zones in a non-sequential manner to apply pressure to at least a portion of a user's limb; and
at least one pressure sensor coupled to the compressor, the at least one pressure sensor operably configured to sense a pressure level provided by the compressor to at least one of the first and second inflation zones.

11. The compression system according to claim 10, further comprising:
a third inflation zone fluidly coupled to the compressor, the compressor operably configured to selectively inflate and deflate at least two of the first inflation zone, the second inflation zone, and the third inflation zone in a non-sequential manner to apply pressure to at least a portion of user's limb.

12. The compression system according to claim 11, further comprising:
a controller operably configured to inflate and deflate the first and second inflation zones according to a predetermined user treatment regimen stored in memory communicatively coupled to the controller.

13. The compression system according to claim 10, further comprising:
a metallic marker coupled to at least one of the outer shell and a user's limb; and
a metallic marker sensor communicatively coupled to the metallic marker and the compressor, the metallic marker sensor operably configured to prevent inflation of at least one of the first inflation zone and the second inflation zone as a result of the metallic marker sensor being within a distance of the metallic marker.

14. The compression system according to claim 10, wherein:
the first inflation zone includes at least one flexible bladder configured to be disposed along a user calf; and
the second inflation zone includes at least one flexible bladder configured to be disposed beneath a user foot.

15. The compression system according to claim 10, further comprising:
an air flow control unit; and
a device storage unit coupled to the outer shell for storing the air flow control unit and the compressor.

16. The compression system according to claim 10, further comprising:
a transmitter coupled to the at least one pressure sensor; and
a processor communicatively coupled to the transmitter and configured to receive data associated with the at least one pressure sensor from the transmitter.

17. A method of promoting circulation, comprising:
providing a compression system for promoting circulation including:
a wearable compression device having:
an outer shell sized and shaped to substantially surround a user's limb, the outer shell including:
an exterior surface; and
an opposing interior surface;
a first inflation zone disposed on the interior surface;
a second inflation zone disposed on the interior surface and fluidly coupled to the first inflation zone;
at least one pressure sensor communicatively coupled to at least one of the first inflation zone and the second inflation zone;
an air tube configured to fluidly couple the first inflation zone to the second inflation zone; and
a compressor coupled to the compression device and the air tube, the compressor operable to selectively inflate and deflate the first and second inflation zones in a non-sequential manner to apply pressure to at least a portion of a user's limb;
coupling the at least one pressure sensor to at least one of the first inflation zone and the second inflation zone; and
selectively inflating at least one of the first inflation zone and the second inflation zone in a non-sequential manner.

18. The method according to claim 17, further comprising:
providing the compression device having a third inflation zone disposed on the interior surface; and
selectively inflating at least two of the first inflation zone, the second inflation zone, and the third inflation zone in a non-sequential manner.

19. The method according to claim 17, further comprising:
providing:
a metallic marker; and
a metallic marker sensor communicatively coupled to the metallic marker and the compressor, the metallic marker sensor operably configured to prevent inflation of at least one of the first inflation zone and the second inflation zone as a result of the metallic marker sensor being within a distance of the metallic marker; and
placing the metallic marker adjacent to an injured user's limb.

20. The method according to claim 17, further comprising:
providing:
a user compliance monitoring system including:
a transmitter coupled to the at least one pressure sensor and configured to transmit data generated by the at least one pressure sensor to a processor communicatively coupled to the transmitter;
coupling the at least one pressure sensor to the at least one of the first inflation zone and the second inflation zone;
reviewing the data generated by the at least one pressure sensor; and
comparing the data to a predetermined treatment regimen.
